(19) United States
(12) Patent Application Publication
(10) Pub. No.: US 2010/0026548 A1
(43) Pub. Date: Feb. 4, 2010

(54) JAMMER DETECTION WITH ADAPTIVE FAST ATTACK/SLOW RELEASE RESPONSE FOR CONTINUOUS AND BURST MODE

(75) Inventors: Haim M. Weissman, San Diego, CA (US); Avigdor Brillant, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/511,986

(22) Filed: Jul. 29, 2009

Related U.S. Application Data
(60) Provisional application No. 61/085,398, filed on Jul. 31, 2008.

(51) Int. Cl. G01S 7/36

(52) U.S. Cl. 342/17

(57) ABSTRACT

Jammer detection is operable in both continuous and burst modes, managing a jammer attack in both cases. Whether in continuous or burst mode, jammer presence is detected according to a burst jammer environment. Results of jammer presence detection are stored to create a history of the jammer presence, and the history is used to manage the jammer attack.

### CLAIM OF PRIORITY UNDER 35 U.S.C. §119

The present Application for Patent claims priority to Provisional Application No. 61/085,398 entitled “Adaptive Dual Mode Fast Attack/Slow Release Operation with Jammer Detection in Continuous and Burst Mode Scenarios” filed Jul. 31, 2008, and assigned to the assignee hereof and hereby expressly incorporated by reference herein.

### REFERENCE TO CO-PENDING APPLICATIONS FOR PATENT

The present Application for Patent is related to the following co-pending U.S. patent application Ser. No.: ______, entitled “Jammer Detection with Mitigation of Detection Threshold Hysteresis Pinch-Off”, having Attorney Docket No. 092057, filed concurrently herewith, assigned to the assignee hereof, and expressly incorporated by reference herein.

### BACKGROUND

1. Field

The present disclosure relates generally to apparatus and methods for communication receivers and, more particularly, to jammer detection.

2. Background

In a conventional communications receiver, there are two conflicting requirements: high sensitivity and high linearity. High sensitivity refers to the receiver characteristic of a low noise figure with high gain so that the receiver is sensitive to a weak signal. High linearity refers to the receiver characteristic of a high third order intercept point (IP3) and a high 1 dB compression point (P1 dBB) so that the receiver has improved immunity against strong signals. High sensitivity receivers often have a relatively lower linearity performance, that is, a lower value for IP3 and P1 dB. On the other hand, high linearity receivers often have a relatively higher noise figure and lower gain. Thus, high sensitivity receivers are optimal for weak signals and high linearity receivers are optimal for strong signals.

However, in many cases there are both weak desired signals and strong undesired signals, or jammers, present in the receiver input. In one example, a weak desired signal and a strong undesired signal (jammer) with higher power are being received simultaneously. In this case, a high sensitivity receiver may have degraded signal-to-noise ratio (SNR) performance due to gain compression and intermodulation distortion because of the presence of the strong jammer in the receiver input. On the other hand, a high linearity receiver may also have degraded SNR performance due to the higher noise level and the presence of the weak desired signal. Thus, the conventional receiver design approach is subject to a compromise between high sensitivity and high linearity, that is, a choice to balance noise figure and IP3 performance.\

One solution to this scenario is to provide a dual mode receiver design which can toggle between a high sensitivity low noise amplifier (LNA) and a high linearity LNA, depending on the input signal environment. If the receiver is in a high sensitivity mode, it may need immediate protection when a strong jammer appears. In one example, such protection is implemented using a fast attack automatic gain control (AGC) circuit which is triggered by a jammer detector (JD). Fast attack refers to a property of the AGC circuit which is a rapid gain reduction after the appearance of a strong input signal level (e.g., jammer). Then, when the strong jammer disappears, the receiver may require a slow release AGC circuit to avoid fast toggling between the two modes. Slow release refers to a property of the AGC circuit which is a slow gain increase after the disappearance of a strong input signal level. In the prior art, there are known fast attack/slow release AGC circuits to provide receiver protection for an input signal environment with strong jammers. However, these known solutions are mainly optimized for an operational mode with continuous reception, and therefore the jammer is received continuously. The assumption of a continuous jammer is reasonable if the jammer environment is slowly varying and there is no fading. Moreover, slow release prevents the receiver from operation in a non-protected mode when a jammer is in a fading null. Therefore, a fast release AGC circuit may cause the JD to be affected by signal fading. Moreover, a fast release AGC circuit may degrade the receiver quality of service because of the jammer presence. As a consequence, a slow release from the protected reception mode is typically favored.

Many scenarios require a receiver to operate in a burst jammer environment, wherein the jammer has a short burst duration. It is desirable to provide for receiving communication signaling in a high sensitivity mode as long as the burst jammer is relatively weak.

### SUMMARY

Jammer detection is operable in both continuous and burst modes, managing a jammer attack in both cases. Whether in continuous or burst mode, jammer presence is detected according to a burst jammer environment. Results of detection are stored to create a history of the jammer presence, and the history is used to manage the jammer attack.

### BRIEF DESCRIPTION OF THE DRAWINGS

Various aspects of a wireless communications system are illustrated by way of example, and not by way of limitation, in the accompanying drawings, wherein:

FIGS. 1 and 2 diagrammatically illustrate a communication receiver according to exemplary embodiments of the present work.

FIG. 3 is a state transition diagram showing examples of AGC switch points and gain states for two jammer detection modes according to exemplary embodiments of the present work.

FIG. 4 graphically illustrates gain levels associated with the gain states of the state transition diagram of FIG. 3.

FIG. 5 graphically illustrates noise figure levels associated with the gain states of the state transition diagram of FIG. 3 according to exemplary embodiments of the present work.

FIG. 6 illustrates communication receiver states according to exemplary embodiments of the present work.

FIG. 7 illustrates a communication receiver power up process according to exemplary embodiments of the present work.

FIG. 8 illustrates an example of MediaFLO Logic channel (MLC) polling according to exemplary embodiments of the present work.

FIG. 9 illustrates an example flow diagram for waking up from a sleep mode according to exemplary embodiments of the present work.

FIG. 10 illustrates an example process for transitioning from jammer detection mode 1 to jammer detection mode 2 according to exemplary embodiments of the present work.

FIGS. 11 and 11A illustrate a polling cycle process for accumulating history of a jammer detector status bit according to exemplary embodiments of the present work.

FIG. 12 illustrates an example of a process for transitioning from mode 2 to mode 1 according to exemplary embodiments of the present work.

FIG. 13 illustrates an example of a super frame according to the FLO (forward link only) standard.

FIG. 14 illustrates an example of a jammer detection integration process according to exemplary embodiments of the present work.

FIG. 15 illustrates jammer detection operations with fast attack/slow release response according to exemplary embodiments of the present work.

FIGS. 16-19 illustrate in more detail dynamic update operations shown in FIG. 15.

FIG. 20 diagrammatically illustrates the jammer detector apparatus of FIG. 2 in more detail according to exemplary embodiments of the present work.

FIG. 21 graphically illustrates an example of threshold levels of wideband and narrow band jammer detectors used in exemplary embodiments of the present work.

FIG. 22 illustrates operations that implement a time hysteresis technique for mitigating hardware jammer detector threshold hysteresis pinch off according to exemplary embodiments of the present work.

FIG. 23 illustrates operations for mitigation of hardware jammer detector threshold hysteresis pinch off that may be performed by a software jammer detector according to exemplary embodiments of the present work.

FIG. 24 diagrammatically illustrates configurability of hardware jammer detector threshold hysteresis pinch off mitigation according to exemplary embodiments of the present work.

FIG. 25 graphically illustrates an example of burst mode jammer evaluation according to exemplary embodiments of the present work.

### DETAILED DESCRIPTION

The detailed description set forth below in connection with the appended drawings is intended as a description of various embodiments of the present work and is not intended to represent the only embodiments in which the present work may be practiced. The detailed description includes specific details for the purpose of providing a thorough understanding of the present work. However, it will be apparent to those skilled in the art that the present work may be practiced without these specific details. In some instances, well known structures and components are shown in block diagram form in order to avoid obscuring the concepts of the present work.

The word “exemplary” is used herein to mean “serving as an example, instance, or illustration.” Any embodiment described herein as “exemplary” is not necessarily to be construed as preferred or advantageous over other embodiments.

Disclosed are a method and apparatus for providing jammer detection in a receiver. In one example, the receiver is a dual mode AGC receiver with a high linearity mode and a high sensitivity mode. In one aspect, the jammer detector for providing the jammer detection is a combination of several complementary jammer detectors, both hardware and software-based. The jammer detector incorporates a narrowband jammer detector (NB JD) to detect inband jammers, a wideband jammer detector (WB JD) to detect out of band jammers, and a software jammer detector (SW JD) for detecting concurrent operation jammers. In one aspect, each of the NB JD, WB JD and SW JD has its own optimized threshold (THⱼ). In one aspect, the jammer detector provides both wideband and narrowband jammer detection for a multiband, multi-standard, dual mode AGC receiver over a broad frequency range. In one aspect the jammer detector algorithm performs initialization at cold start. In one aspect the jammer detector algorithm performs initialization during burst mode operation when the receiver is wakes out of sleep mode. In one aspect the jammer detection accumulates a history of jammer presence during a polling observation of a JD status bit to determine whether to switch between jammer detection modes. In one aspect, the jammer detector algorithm accumulates a history of jammer presence during polling observation of JD status bit to determine the operational mode when operating in burst mode. In one aspect, respective AGC switch point tables are selected based on the mode of operation decision.

Some embodiments provide a hardware and software solution that measures the jammer presence during a burst jammer event, and stores the measured results to create a history of the jammer presence.

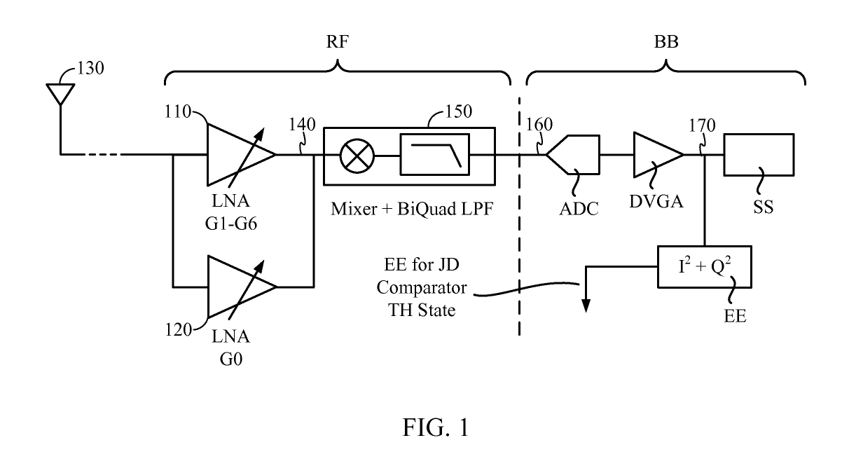

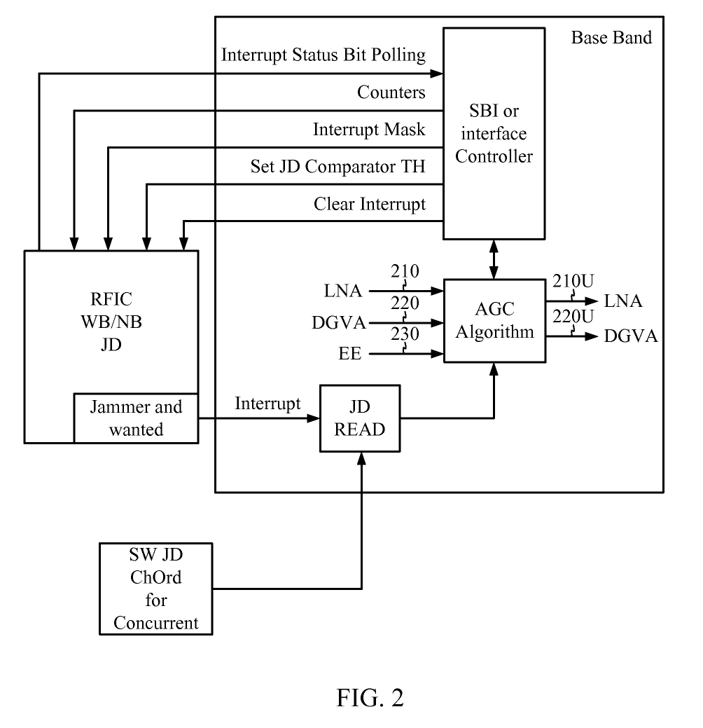

FIG. 1 diagrammatically illustrates a communication receiver with two JD modes according to exemplary embodiments of the present work. Mode 1 has high sensitivity and low linearity. Mode 2 has high linearity and moderate sensitivity. Mode 1 employs an LNA 120 with low noise figure, high gain, and low current consumption. Mode 1 is used when a low level jammer or no jammer is present at the receiver input. Mode 2 employs an LNA 110 with lower gain, higher IP3, and higher current consumption than LNA 120. Mode 2 is used when a high level jammer is present in the receiver input. Referring also to FIG. 2, the transition between the two JD modes is implemented by an automatic gain control circuit (designated AGC) triggered by a jammer detector (designated JD).

An input RF signal is captured by a receive antenna arrangement 130, and is sent to the inputs of both Mode 1 LNA 120 and Mode 2 LNA 110 for low noise amplification and production of the Mode 1 output RF signal and Mode 2 output RF signal, respectively. The AGC circuit of FIG. 2 selects between the Mode 1 LNA 120 and the Mode 2 LNA 110 to yield a selected output RF signal 140. The selected output RF signal is then sent to mixer/low pass filter (LPF) block 150 for frequency downconversion and production of an input baseband (BB) signal 160. The input baseband signal 160 is sent to an analog-to-digital converter (ADC) for conversion to a digital signal. This digital signal is then sent to a digital variable gain amplifier (DVGA) for gain adjustment and production of an output digital signal 170. The output digital signal 170 is then sent to a sample server (SS) block that contains the data (e.g., symbol data) used for demodulation, and also to an energy estimator (EE) for estimation of the energy of the output digital signal. The estimated energy may be used in conventional fashion to produce threshold levels for use in one or more jammer detectors (see JD in FIG. 2), based on a gain state decision that is in turn made based upon the EE value. The gain state is specified by an AGC table (described further below) of Mode 1 or Mode 2, and the threshold level for the JD is set based on the gain state (i.e., the greater the signal attenuation of the gain state, the lower the threshold, and vice versa).

FIG. 2 illustrates a jammer detector (JD) and automatic gain control (AGC) circuit according to exemplary embodiments of the present work. A (conventionally available) JD input signal that contains both the jammer and the desired signal is sent to the JD for detection of a high level jammer. If the jammer level exceeds a predetermined threshold TH, a JD interrupt signal is generated by the JD and sent to the AGC circuit. The AGC circuit (implemented, in some embodiments, in a DSP or other suitable data processing circuit) accepts the JD interrupt signal, as well as the current LNA gain state 210, the current DVGA gain state 220, and the current energy estimate 230, as inputs to the AGC circuit. The outputs of the AGC circuit are an updated LNA gain state 210U, an updated DVGA gain state 220U, and a new JD threshold value, based on the appropriate AGC table. These AGC outputs are produced based on the various AGC inputs noted above. The AGC circuit incorporates AGC Tables which provide parameters associated with Mode 1 and Mode 2. For example, if the receiver is currently in Mode 1 (high sensitivity state) and the JD interrupt signal is asserted HIGH, to indicate the presence of a high level jammer, the AGC circuit will select Mode 2 and set the updated LNA gain state 210U, the updated DVGA gain state 220U, and the JD threshold to appropriate values based on the AGC Table associated with Mode 2. Similarly, for example, if the receiver is currently in Mode 2 (high linearity state) and the JD interrupt status remains LOW for a predetermined period of time (called the JD release period and described further below), which is the polling period of the interrupt status bit of the JD. This indicates the absence of a high level jammer, so the AGC circuit will select Mode 1 and set the updated LNA gain state 210U, the updated DVGA gain state 220U, and the JD threshold level to appropriate values based on the AGC Table associated with Mode 1.

In some embodiments, each jammer detector (JD) has its own associated threshold register which holds the threshold value for that JD. In some embodiments, a common threshold register contains the respective threshold values for each JD.

In one aspect, the Mode 2 LNA 110 has a plurality of gain states. In one example, the Mode 2 LNA has three gain states, G1, G2, and G3, in order of decreasing gain and increasing IP3 and P1 dBB at the expense of noise figure. In some embodiments, Mode 2 may have two other additional gain states G4 and G5, advanced retard switch points, as appears in FIG. 3, based upon receiver linearity requirements. Depending on the details of the AGC circuit, the gain state of the Mode 2 LNA 110 will be set dependent on the crossing of an AGC switch point. In some embodiments, the Mode 1 LNA 120 has a plurality of gain states. In some cases, high gain state switch points are merged, since the linearity requirements at high gain states for Mode 1 and Mode 2 are the same. This switch point merging reduces complexity.

In some embodiments, the AGC contains two sets of AGC lookup tables respectively corresponding to the two JD modes. In one example, for Mode 1, the lookup table switch point (SP) threshold for a transition from gain state G0 to gain state G1 is approximately −80 dBm. The gain state G0 corresponds to the low noise figure, high gain LNA path in Mode 1. In one example, for Mode 2, the AGC lookup table SP threshold for a transition from gain state G0 to G1 is set very low, for example, set to approximately −200 dBm, so that effectively the gain state G0 is skipped and gain state G1 is active at lower input signal level conditions.

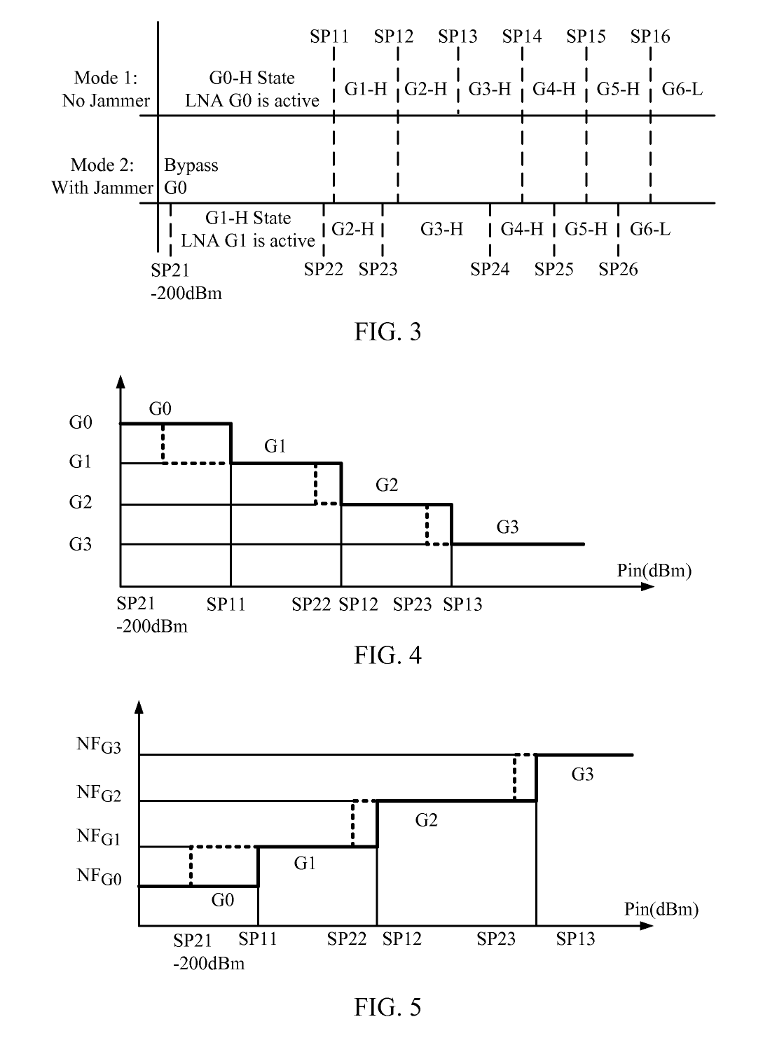

FIG. 3 illustrates a state transition diagram for the two receiver modes in terms of the switch points (SP) and gain states. The top line shows the state transitions for Mode 1 and the bottom line shows the state transitions for Mode 2. FIG. 4 shows receiver gain levels (associated with gain states of FIG. 3) as a function of input RF level for both Mode 1 (high sensitivity) and Mode 2 (high linearity). FIG. 5 shows receiver noise figure levels (associates with gain states of FIG. 3) as a function of input RF level for both Mode 1 (high sensitivity) and Mode 2 (high linearity). Each gain state of each mode has an associated gain level and an associated noise figure level. In FIGS. 4 and 5, Mode 1 parameters are shown by solid line, and Mode 2 parameters are shown by broken line.

In some embodiments, the SP lookup table threshold settings in the AGC are updated when switching between modes.

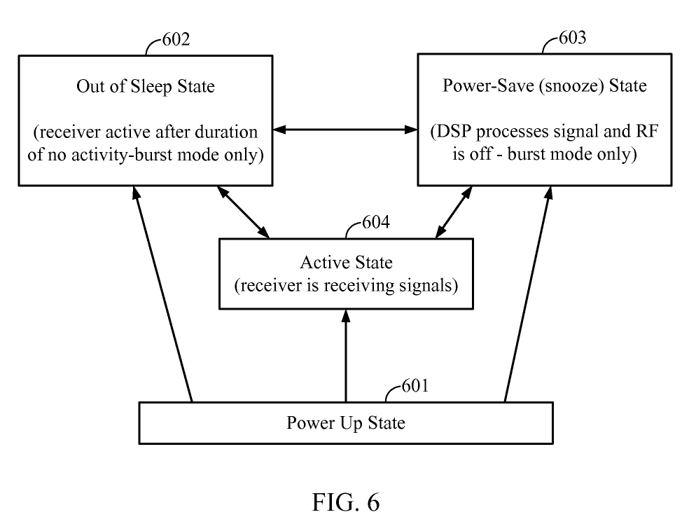

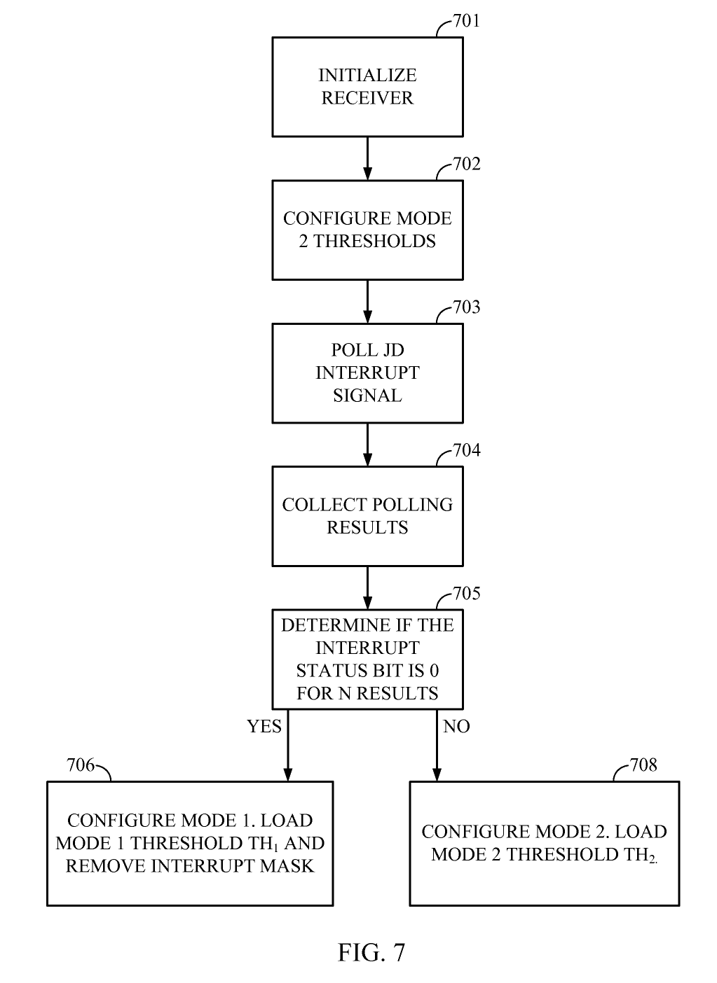

As illustrated in FIG. 6, the receiver operation is generally characterized by a number of states for both burst mode and continuous mode. Power up state 601 is also known as cold start when turned on (common to both continuous and burst modes). In the out of sleep state 602, the receiver wakes up to be active after duration of no activity (burst mode). Power-save (snooze) state 603 is a burst mode operation state where the signal was received by BB via the RFIC, Off air receiving had terminated, i.e. RF burst terminated, the RFIC was turned off by a processor to save power and only the baseband circuitry and processor are active to process the received data. Snooze is an intermediate state between Active state and Sleep state. A digital signal processor (DSP) processes the signal after it is received and the RF signal is off (burst mode). Active state 604 receives signals (common to both continuous and burst modes).

### Transitions for Burst Mode are:

a. Cold Start (Initialization process)
b. Active Mode
c. Snooze
d. Sleep
e. Wakeup (Initialization process)
f. Active Mode
g. Snooze
h. Sleep

If turn off is activated, the receiver is turned off

### Power Up State

In one example, the power up process has the following steps (as illustrated in FIG. 7) while operating with jammer detection.

Initialization at 701
Initialize radio frequency integrated circuit (RFIC) configuration
Mask JD interrupt by setting INT_ENABLE to low (interrupt inhibit)
Ignore JD.

Mode 2 strong jammer thresholds are loaded at 702
On power up Mode 2 thresholds (TH₂) are configured when RFIC is configured.

One purpose of this is to turn on in protected mode (mode 2) at cold start when in an unknown environment. Alternately, the wake up process can begin in Mode 1 and, if a strong jammer is present, fast attack operation based on an interrupt from the JD will transfer the receiver to Mode 2. This approach provides the possibility of more high sensitivity time in G0 if the environment has weak jammers, because the release time of Mode 2 is avoided.

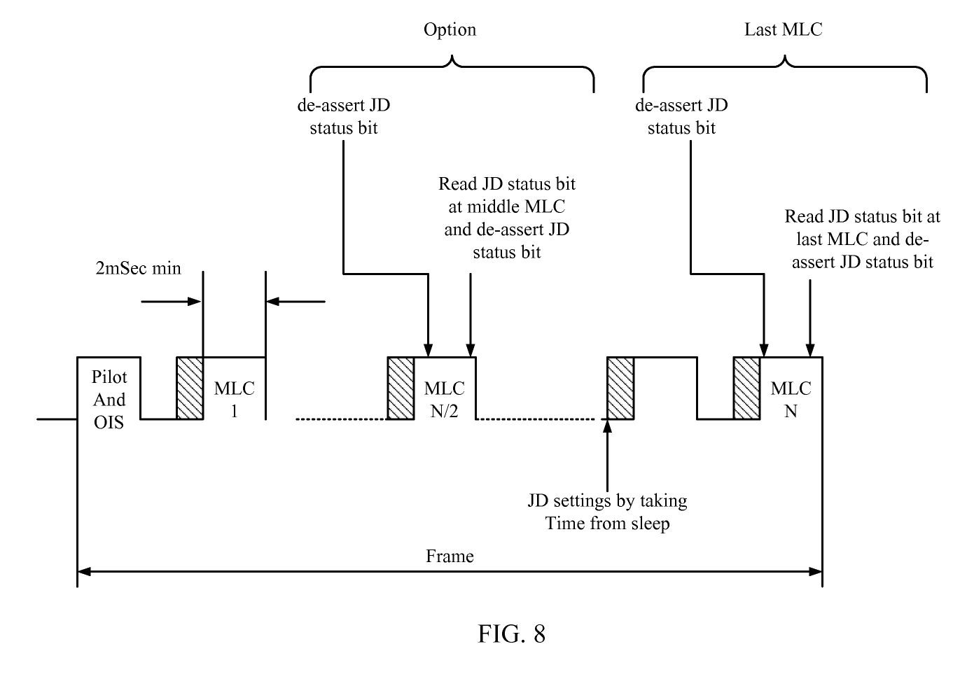

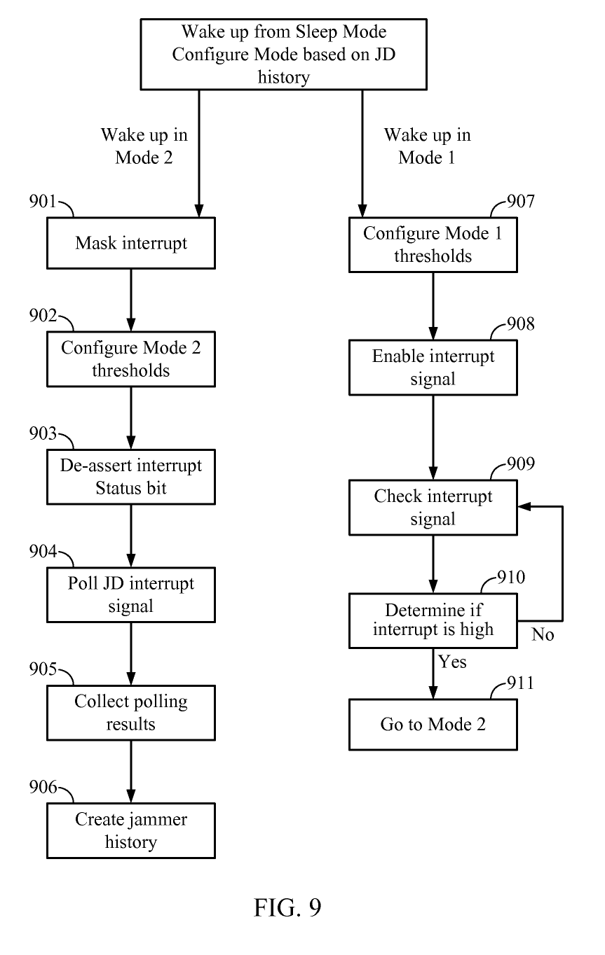

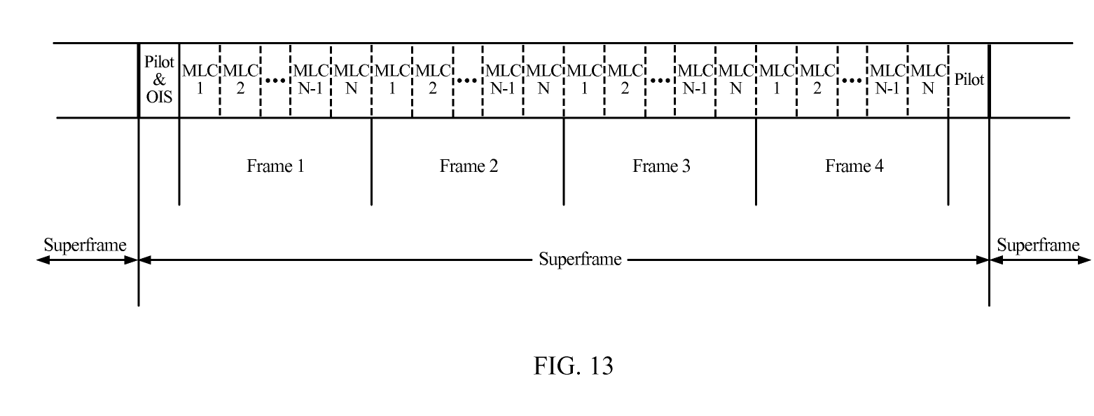

Poll JD interrupt status bit at 703. A data processor such as a DSP (or other type of data processor) conventionally sets an interrupt status bit in a register in response to occurrence of a corresponding interrupt event, in this case activation of a corresponding JD interrupt signal by the jammer detector JD (see also FIG. 2). The interrupt status bit gets set even if the corresponding interrupt signal is masked (disabled) such that the DSP does not trap to an interrupt handling process in response to activation of the interrupt signal.
De-assert interrupt status bit prior to each poll at the beginning of a burst (Interrupt status bit is “0”).
DSP performs polling cycle on interrupt status bit within, for example, 1 second.
   In a continuous mode example, the interrupt status bit is examined 4 times each 250 msec.
   FIG. 8 illustrates a conventional FLO frame of N MediaFLO Logic Channels (MLCs). Each MLC time slot shown in FIG. 8 is a content channel. For example, switching to a different TV channel means switching to a different MLC slot. Some content channels may occupy multiple MLC slots. In the burst mode, N consecutive frames are polled by checking the interrupt status bit at the last burst in a frame as illustrated, for example, in FIG. 8. In the example shown in FIG. 8, the approximate length of a frame is 250 msec. A super frame contains four frames as shown in FIG. 13, so a super frame is 1 second. Hence, there are 4 potential events in which the status bit is checked in a frame of 1 sec and therefore the polling rate is 4 Hz.
DSP collects the polling results at 704. For example:
   If after 3 consecutive polling cycles of 3 superframes, for example, while observing the last MLC of each frame (there are 4 MLC results for the interrupt status bit per super frame in the FLO example, hence 12 results for 3 seconds; therefore, 12 polling results correspond to 3 superframes and 3 seconds release time), the interrupt status bit remains “0” at 705, meaning no strong jammer for 3 seconds, the DSP will drive the RFIC to mode 1 (high sensitivity) at 706.
   If polling shows at 705 that the interrupt status bit was set back to “1” at some point during the 3 consecutive polling cycles, meaning a relatively strong jammer is still present, the DSP will keep the RFIC in mode 2 (708).
   If in mode 1 at 706:
      Load mode 1 threshold (TH₁)
      Remove interrupt mask

The above techniques have been described with respect to a forward link only (FLO) system as an example. Other embodiments apply these techniques on other types of TDMA and burst mode systems.

Among various embodiments:
Burst duration varies;
Number of polling retries varies;
Polling rate varies;
Number of consecutive polling cycles varies;
Data processors other than a DSP are used;
The total polling time used by the mode 2 jammer detection varies

### Out of Sleep State

In one example, when in the out of sleep state 602 of FIG. 6, the following steps are employed (as illustrated in FIG. 9).

4 Mode 2 or mode 1 thresholds are loaded based upon the last jammer detection history. For example the last 3 polling cycle results are stored as a decision marker.

(In the case of FLO, 3 cycles of 4 results collected within 3 seconds provide 12 samples of the JD interrupt status bit. All must be “0” to trigger loading mode 1 threshold information).

The above techniques have been described with respect to a forward link only (FLO) system as an example. Other embodiments apply these techniques on other types of TDMA and burst mode systems.

Among various embodiments:
Burst duration varies
Number of polling retries varies
Polling rate varies
Number of consecutive polling cycles varies
Amount of poling result history retained varies;
Data processors other than a DSP are used;
The total polling time used by the mode 2 jammer detection varies
   The RFIC, when waking up from a sleep mode, can be configured in mode 2 or mode 1 based on jammer history. This history is stored during previous polling. The RFIC will wakeup in a specific mode per the history and will perform different activities as described below.

Mode 2
Mask the interrupt at 901.
Configure Mode 2 thresholds (TH₂) at 902 when RFIC is configured.
De-assert interrupt status bit (Interrupt status bit is “0”) at 903.
Poll jammer status at 904, collect the polling results at 905, and create jammer history at 906.

Mode 1
Configure Mode 1 thresholds (TH₁) at 907 when RFIC is configured.
Enable the interrupt at 908
Operate at Mode 1 until an interrupt is received, as shown at 909 and 910.
If an interrupt is received at 910, go to Mode 2 at 911.

### Active Mode State

The RFIC receiver (or any kind of receiver) can operate in burst mode and in continuous mode. The mode in which the receiver is actively receiving data is defined as active mode. Active mode can be in bursts (as in TDMA) or continuous. In either burst mode or continuous mode, the receiver can operate either at mode 1 or mode 2. During the active mode state, transitions from mode 1 (high sensitivity low linearity) to mode 2 (high linearity moderate sensitivity) may occur.

Examples herein are demonstrated with respect to the FLO standard which operates in burst mode with varying burst duration. However, one skilled in the art would understand that, although some changes to some parameters (listed below) may be desirable, the techniques described are applicable to any burst receive standard and to any continuous receive standard.
Different number of polls to accumulate history
Defining release time based on scenario and environment of operation such as
   Mobile
   Stationary
   Quiet
   Many jammers
Defining samples of jammers per slot (polling activities on interrupt status bit while interrupt is masked)

Mode 1 to Mode 2 Transitioning

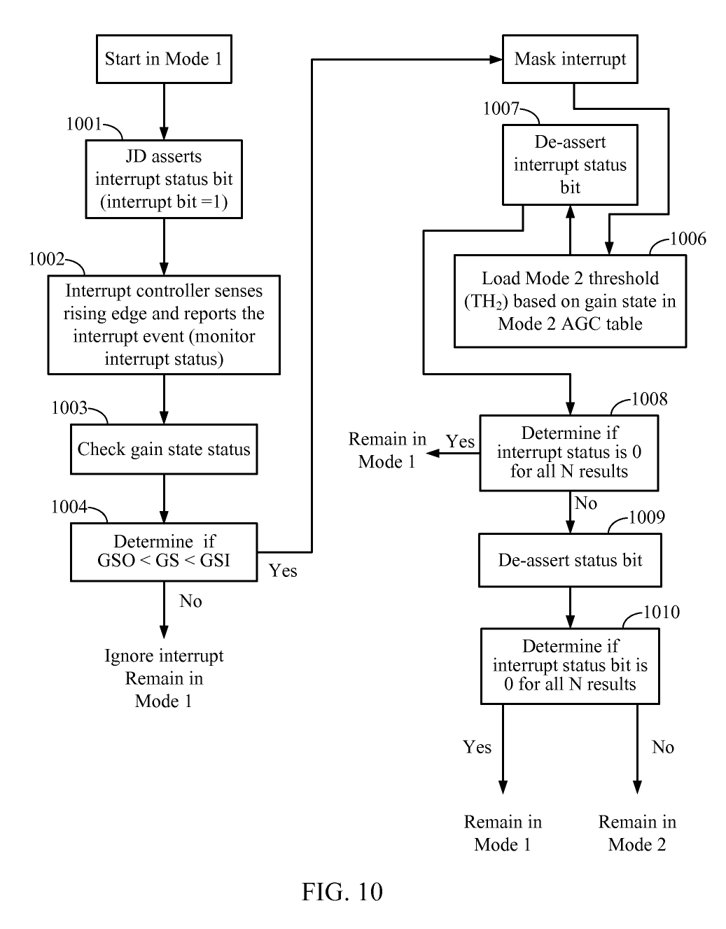

An example of the process of transitioning from mode 1 to mode 2 is illustrated in FIG. 10 and described below.

JD asserts interrupt status bit (due to the integration result showing a jammer) to be “1” at 1001
Interrupt status bit is not masked
DSP interrupt controller senses the rising edge of an interrupt and reports the interrupt event at 1002.
DSP checks gain state status at 1003.
If gain state (GS) is not within G0≦GS≦G1 at 1004, ignore the interrupt.
If G0≦GS≦G1 at 1004, operation proceeds to 1005.
DSP masks the interrupt at 1005.
At 1006, DSP switches to Mode 2 AGC table and loads threshold TH₂ based on the gain state from the table
At 1006, DSP switches to Mode 2 AGC table and loads threshold TH2 based on the gain state from the table
At 1007, DSP de-asserts the interrupt status bit after all settings are done, to avoid a false alarm on the JD status bit.
DSP performs polling of interrupt status bit at 1008. For example, using the
   FLO standard, perform 3 polling cycles of 1 second each.
If after 3 consecutive polling cycles at 1008, all N results for the interrupt status bit are “0”, Mode 1 is retained.
If the polling at 1008 shows that the interrupt status bit was set back to “1” (i.e., jammer is still present), the DSP de-asserts the interrupt status bit at 1009 and performs 3 additional polling cycles of the interrupt status bit (to collect 12 results for the FLO example) at 1010.
If after the polling at 1010, all N interrupt status bit results are “0”, then Mode 1 is retained. Otherwise, change from Mode 1 to Mode 2.

Mode 2 to Mode 1 Transitioning

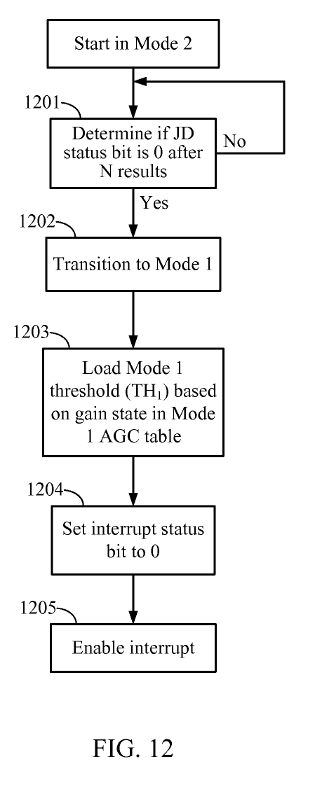

An example of the process of transitioning from mode 2 to mode 1 is illustrated in FIG. 12 and described below.
Transitioning to (high sensitivity) Mode 1 is based on JD polling history. For example, if 12 consecutive polling results for the interrupt status bit show “0” (i.e., weak jammer), then the DSP will decide to go to mode 1 at 1202.
At 1203, change the AGC table to be the Mode 1 table, and load Mode 1 threshold (TH₁) based on the gain state from the table
Set interrupt status bit to “0” at 1204
Enable interrupt at 1205 (interrupt mask is removed)
The number of consecutive polling results defines the release time (e.g., 3 seconds).
   Examples of parameters are:
      FLO burst of 2 msec (MLC minimal length)
      FLO frame of 250 msec
      FLO super frame of 1 sec
      4 interrupt status bits are checked in a frame
      Polling rate of 4 Hz
      3 seconds release time means polling of 3 super frames (12 frames total)

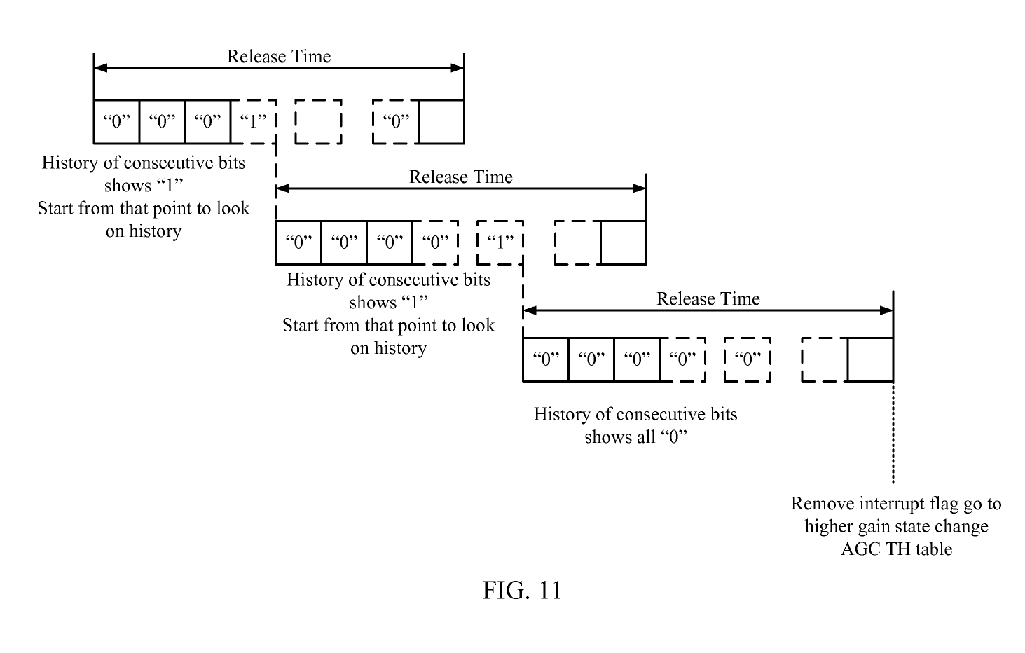

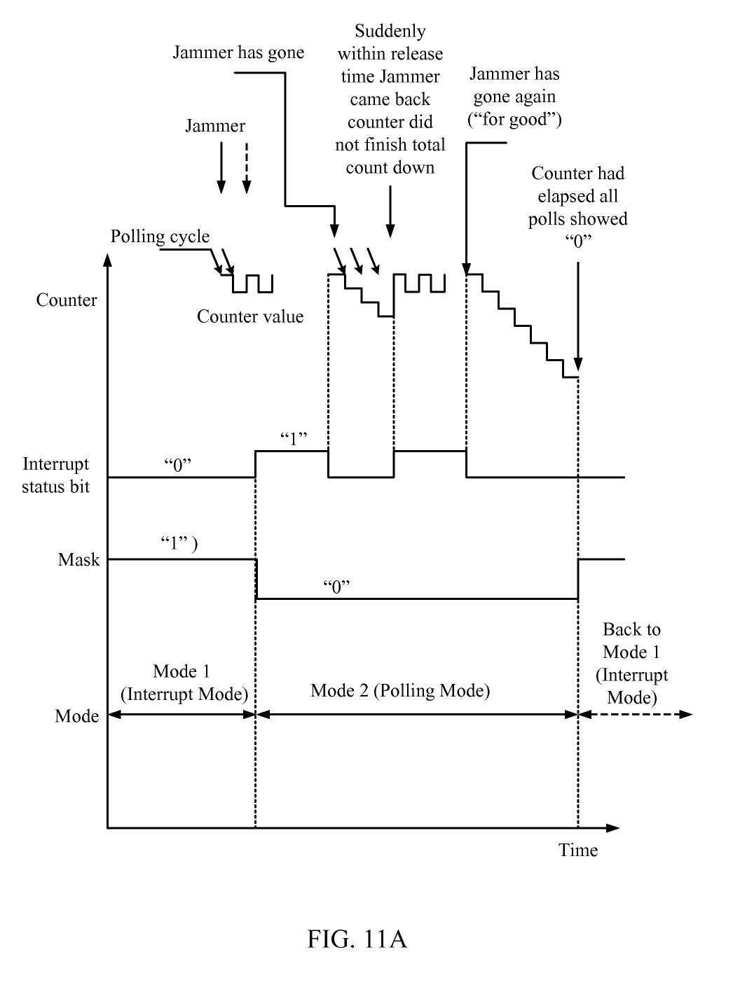

The accumulation of interrupt status bit polling history according to exemplary embodiments of the present work is illustrated in FIG. 11 (and also in FIG. 11A). The history accumulation supports the requirement that all polled interrupt status bit values must show “0” to permit Mode 1 operation. The polling occurs during the release time interval. If the interrupt status bit is asserted to “1”, this means that a jammer is present. To permit Mode 1 operation, the interrupt status bit must be “0” for the entire release time interval. The interrupt status bit value is read during polling. Each interrupt status bit result is produced by the JD after an integration time. Accumulation of polling history during a given release time interval indicates presence or absence of a jammer. The release time interval associated with the polling process is purposefully slow to avoid the effects of fading and slow flat fading as well.

During the polling process the processor does not directly observe the interrupt (it is masked). The polling process is executed instead. If it is determined that the entire history of polling during the release time interval shows that all polled interrupt status bit values were “0”, then, at that instant, after departing to Mode 1 and implementing the required RFIC settings for Mode 1 operation based on a gain state from the Mode 1 AGC table, the interrupt mask is removed and the processor directly observes the interrupt (this is a switch to Mode 1). In some embodiments, interrupt reading and reacting occurs only for certain defined gain states such as G0, G1,G2 in Mode 1. At higher gain states for either Mode 1 or Mode 2, the JD is ignored and neither direct observation of the interrupt signal nor polling of the interrupt status bit is performed. For example if the receiver is at gain state 4 of Mode 1, the interrupt may be masked, because the AGC high attenuation of gain state 4 already protects the receiver against jammers. Another example is gain state 4 of Mode 2: a switch to Mode 1 may not be necessary because the relevant AGC switch points may merge, such that the mode switch may provide no advantage.

Jammer detection attempts to exploit instances of a jammer free environment and increase sensitivity as much as possible. FIGS. 11 and 11A demonstrate a method which saves time in the interrupt status bit polling that occurs during the Mode 2 release process. As the interrupt status bits are accumulated, if one of those bits indicates “1” as shown in FIG. 11 (see 111 and 112) and FIG. 11A, the release time automatically resets and a new history of interrupt status bit is collected. At the instant when all interrupt status bits show “0” (see 113), the processor switches to Mode 1 and removes the interrupt mask. This operation saves time. More specifically, if a decision to remain in Mode 2 were taken at the end of all polling within a given release time interval (e.g., at a time later than 111 or 112), the eventual decision to switch to Mode 1 at 113 would occur later than shown in FIG. 11. Because any single interrupt status bit value of “1” disqualifies the entire polling history for the release time interval, a new release time interval may be started upon the first occurrence of a “1” during interrupt status bit polling. Pipelining the process as described above and illustrated in FIG. 11 achieves shorter convergence to a Mode 2-to-Mode 1 switch, without shortening the release time interval itself.

The following description illustrates an example of a fast attack/slow release AGC circuit when the receiver is at a high gain state.
When receiver is at high gain states (meaning, as used herein, relatively high signal attenuation conditions), for example, G2 and above for Mode 1 or G3 and above (also designated as G3(+) below) for Mode 2 (see also FIG. 4), the interrupt is masked and polling of the interrupt status bit is not performed.
When the receiver plans to move to G2 in Mode 2 (per AGC direction), the following occurs:
   If at mode 2:
      Load JD comparators threshold reference level of G2 in Mode 2. (The decrease in signal attenuation associated with the move from G3(+) to G2 causes the JD comparators threshold to be higher, i.e., the JD threshold of G2 is higher than the JD threshold of G3.)
      De-assert interrupt status bit
      Keep interrupt mask
      Perform polling
When receiver plans to move to G1 in Mode 1 (per AGC direction), the following occurs:
   If at mode 1:
      Mask JD interrupt (to prevent false alarms during set up)
      Load JD comparators threshold reference level of G1 in mode 1. (The decrease in signal attenuation associated with the move from G2(+) to G1 causes the JD comparators threshold to be higher, i.e., the JD threshold of G1 is higher than the JD threshold of G2.)
      De-assert interrupt status bit.
      Remove interrupt mask.
         One Example of Burst Mode Operation with FLO Timing

FLO Standard Background

The following description illustrates an example of the operation of an adaptive dual mode fast attack/slow release AGC circuit with jammer detector in burst mode for FLO timing.

The jammer detector fast attack/slow release AGC circuit operates in burst mode. The polling history of the previous consecutive bursts is kept. The FLO burst mode operation is merely one example of a burst mode environment. The polling parameters are programmable.

FIG. 13 illustrates an example of the FLO standard as a slotted mode with the following definitions.
Sample—The smallest unit of time. For 5 MHz channel, the baseband sample rate of the system is 55.5 MHz; hence each sample is 0.018 microseconds (18 ns) in duration. For 6 MHz, 7 MHz and 8 MHz modes, the baseband sample rate of the systems are 66.6 MHz, 77.7 MHz and 74 MHz, respectively and sample times are 15 ns, 12.87 ns, and 13.5 ns respectively.
Symbol—A collection of samples. Each symbol contains the active carriers, the cyclic prefix, and windowing. In one example, the total duration of a symbol is 833.25 microseconds. The smallest symbol is for the 2K fast Fourier transform (FFT) mode in 8 MHz bandwidth ((256+2048+17)*13.5 ns)=31.33 μsec.
MLC slot—MediaFLO Logic channel, a variable slot in time containing the data to be received. Each MLC slot is a content channel. For example, switching to a different TV channel means switching to a different MLC slot. Some content channels may occupy multiple MLC slots. The duration of a MLC slot depends on the data rate of the content, and may range from several symbols to hundreds of symbols.
Frame—A collection of all MLC slots on one RF channel. In one example, each frame is roughly 250 milliseconds.
Super frame—Super frame is the largest unit of time. For example, a super frame is a collection of 4 frames, 18 symbols for pilots and overhead information symbols (OIS), and 2-14 symbols for positioning pilots. Each super frame contains exactly 1200 symbols and lasts 1 second.

### One Example of JD Implementation for FLO

Description of Digital Integration

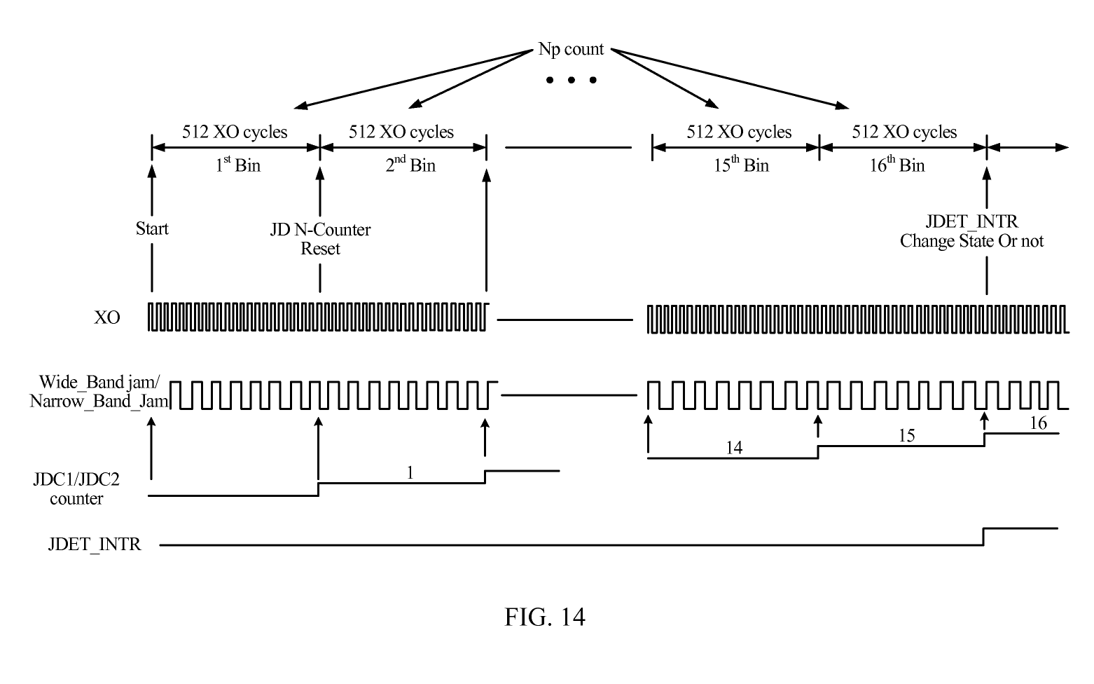

An example for the implementation of the jammer detector for the FLO environment is described with respect to FIG. 14. This example demonstrates a JD algorithm for burst mode, also known as slotted mode or time division multiple access (TDMA). Various embodiments operate with various burst mode (TDMA) standards. The example describes the NB JD (narrow band jammer detector) operation but can be implemented by the WB JD (wide band jammer detector). Moreover, the JD digital integrator itself may be realized in variety of ways.

The time constant of one or more JDs is defined by the integration period of the JD digital integrator.
A counter Np counts 512 TCXO (temperature compensated crystal oscillator) cycles.
A JDC1 or JDC2 counter counts 16 consecutives Np cycles. The JDC1 and JDC2 counters measure how many times the Np counter makes a successful 512-count cycle with the input signal exceeding a jammer detection threshold. JDC1 corresponds to a threshold for an adjacent jammer, and JDC2 corresponds to a threshold for an alternate jammer. To accomplish an interrupt in this example, JDC1 or JDC2 should count 16 successful instances of the 512-count cycle of the Np counter.
TCXO frequency is approximately 19.2 MHz.
   The integration period T is given by equation 1.1 and illustrated in FIG. 14, wherein the JD integration process is seen to be an accumulation of count values (the Np count value multiplied by the JDC1 or JDC2 count value) to produce a JD interrupt.

$$T \approx 512 \times 16 \times \frac{1}{{f}_{TCXO}} \approx 426.67 µSec \qquad ( 1.1 )$$

### JD Considerations for Operation in Burst Mode

The minimum MLC slot duration is 2 msec for FLO. This is approximately 4 times longer than the JD minimum integration period of time. Thus the interrupt status bit sampling occurs at the end of an MLC slot (see also FIG. 8). This guarantees a reliable, stable interrupt status bit reading during the polling process. The jammer detection process converges within 426 μsec (equation 11) as a minimum. If the signal is random, convergence might take about 1.5 msec due to the signal peak to average nature. Thus, as was explained, the interrupt status bit observation occurs at the end of the MLC. The flexibility of defining the digital integration time (e.g., by setting the aforementioned counter values) may be used to adjust convergence time based upon burst size up to a certain minimum. The minimum is defined by the statistical ratio of false alarms to misdetection.

For a stable reading interrupt status bit polling is performed at the end of the MLC slot if it is a short burst. If MLC slot has a long duration, there is an option to perform several polls on the same MLC slot. If the MLC is too short, then polling is ignored on that MLC, and another MLC with a longer duration is observed.

To avoid DSP overload, some embodiments perform interrupt status bit polling only at the last MLC slot of a frame. However, it is also acceptable to make several polls on a frame or one at the end MLC slot and one at the middle of a frame (MLC that is in the middle of a frame) depending on the application. An example of this is shown in FIG. 8, wherein the interrupt status bit is denoted “JD status bit”.

If polling is made on an MLC slot at the middle of a frame and on the last MLC slot of the frame, this will increase the total number of polling results to 24, meaning two poll results per frame. This is because there are four frames in a super frame and the example release time is 3 seconds (i.e., 3 FLO super frames). A total of 24 polling results per 3-second super frame gives an 8 Hz polling rate.

### Process

In some embodiments, polling the last MLC slot (receive burst) of a FLO frame (see also FIG. 8) includes the following:
Read interrupt status bit
Store interrupt status bit value (“0” or “1”) with respect to the frame read.
   This is done in order to see the 12 consecutive statuses in 3 FLO super frames and to make a decision regarding how to wakeup the RFIC in the next slot (Mode 1 or Mode 2).
   The process is a jammer history accumulation.
In transitioning from the sleep mode to the active mode, the following activities occur. (See FIGS. 3-5 for the gain states definitions vs. input power.)
   If at Mode 1 and the gain state satisfies G0≦GS≦G1 and there is no jammer:
      Interrupt is enabled
      Interrupt status bit is de-asserted
      The DSP will be notified of a jammer by an interrupt. Gain state G1 in Mode 1 operates at a higher RF power range compared to gain state G1 in Mode 2.
   If at Mode 1 and the gain state satisfies G1<GS
      Interrupt is disabled
      Ignore JD interrupt and no polling.
   If at Mode 2 and the gain state satisfies G1≦GS≦G2
      Interrupt is disabled
      Interrupt status is de-asserted
      Read JD status bit at the end of MLC slot.
      DSP will be notified of a jammer by polling.
   If at Mode 2 and the gain state satisfies G2<GS
      Interrupt is disabled
      Ignore JD interrupt and no polling.

### One Example of JD Fast Attack/Slow Release Operation for FLO

A jammer detector operating in burst mode is described below, and burst sampling is illustrated in FIG. 8 as shown earlier. One skilled in the art would understand that the process described herein is also applicable to other TDMA operation mode. The parameters are adjustable, and they include: number of polls in the MLC slot, number of MLC slots being polled per frame and gain states in which the JD starts to be active.

Prior to the active receive burst, there is an initialization process (described herein) and settling time for the receiver.
1. Receiver is at Mode 1 or 2 depending on history of JD status bits.
2. If at Mode 2
   a. Mask interrupt
   b. Set interrupt status bit to “0”
3. Wakeup at mode 2 (history did not show case to go to mode 1).
4. Check gain state (GS). FIGS. 3-5 show the gain states and switch points for the mode of operation.
5. If the gain state is GS>G2, do not perform any polling until the last MLC slot of the next frame.
6. If the gain state is G1≦GS≦G2, take the last MLC slot in a frame
   a. From wakeup to the last frame MLC slot, set JD status bit to “0”
      Further accelerate by ignoring JD status bit and resetting the JD status bit on the last MLC slot in a frame.
         i. If each MLC slot in a frame is observed, then each time there is a need to reset status bit.
         ii. JD or Interrupt Status bit is observed at the middle of MLC slot or close to its end.
         iii. If MLC slot is too short, then ignore it.
   b. Read JD status bit at last MLC slot in a frame.
   c. Set JD status bit to “0”
   d. Attach it to the frame reading index
   e. Repeat the process with the next frame
7. Perform process (a-e) over three (3) super frames. With one interrupt status bit poll at the end of each frame, four (4) interrupt status bit values are collected from 4 frames within a cycle of 1 sec. Twelve (12) reads are taken for three super frames. This results in 3 seconds at a polling rate of 4 Hz.
8. Determine if all the 12 consecutive polls report JD status=0. (If any polling result yields “JD status bit=1”, then the history accumulation starts all over again as shown by FIGS. 11 and 11A.)
9. If not, maintain mode 2 and restart again from step 5 since the gain state may change.
10. If yes at step 8 above, go to mode 1.
   a. Set interrupt status bit to “0”
   b. Enable interrupt
   (The next wakeup will be in mode 1 if the DSP did not receive an interrupt.)
11. When wakeup in mode 1
   c. Reset status bit (since wakeup may load “garbage” to status bit).
   d. Enable interrupt

### One Example of a Burst Mode Fast Attack/Slow Release Sweep Algorithm

An example of a fast attack/slow release AGC circuit under burst mode operation is described. The example may be implemented in software, firmware, hardware or combination thereof. In one example, the receiver is used as a spectrum analyzer to perform a sweep by “stealing” time from sleep duration and shortening the sleep time. In another example, a fast sweep using frequency hopping, rather than continuous operation, is performed to increase sleep time; however, this mode may sacrifice detection fidelity.
Receiver performs RF sweep over relevant frequency bands covering the receive frequency.
Perform sweep process prior to wakeup from sleep mode.
Perform sweep process using an infinite impulse response (IIR) averaging algorithm with weighted history
   Cold start
      For first time, perform a sweep K times and average it in order to gain weighted history
         For example, K=8, 16, 32
   On going
      Prior to wakeup, perform a single sweep
      Measure
      Average with respect to history

(Since during active mode, the JD reports are from one or more JDs, no sweep process occurs.)

1 An example of an averaging IIR algorithm is described.

$${Ch\_Power}_{j = M} = \frac{1}{M} [ \begin{matrix}{Ch\_Power}_{j = M} + C \times \\ ( {\sum }_{j = 2}^{M - 1} {Ch\_Power}_{j} + \frac{1}{N} {\sum }_{k = 1}^{N} {Ch\_Power}_{k} )\end{matrix} ]$$

M is the number of slots measured
N is the number of sweeps made at first time turn on where j=1
1≦j≦M−1 is the history power index
j=M is the current measurement
C is a weighting coefficient

Another example of an averaging IIR algorithm includes adaptive averaging with a higher weight for peak power

Ave=W1i*AVE+W2(i)*Iin

If Iin>Ave

W2(i)=W2(i−1)+1

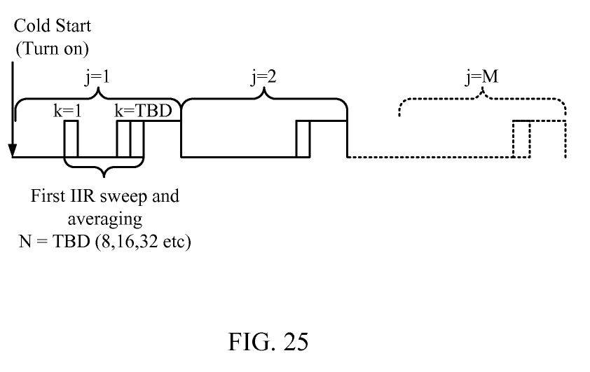

W1(i)=W1(i−1)−1

Where W1 is a weight coefficient for the history power average. W2 is a weight coefficient for the current read power, Iin is the current read of jammer input power Ave is the history average jammers power, i is current state index and (i−1) is previous state index. FIG. 25 illustrates an example of the process of jammer evaluation during burst mode and making a jammer decision based on burst reception history.

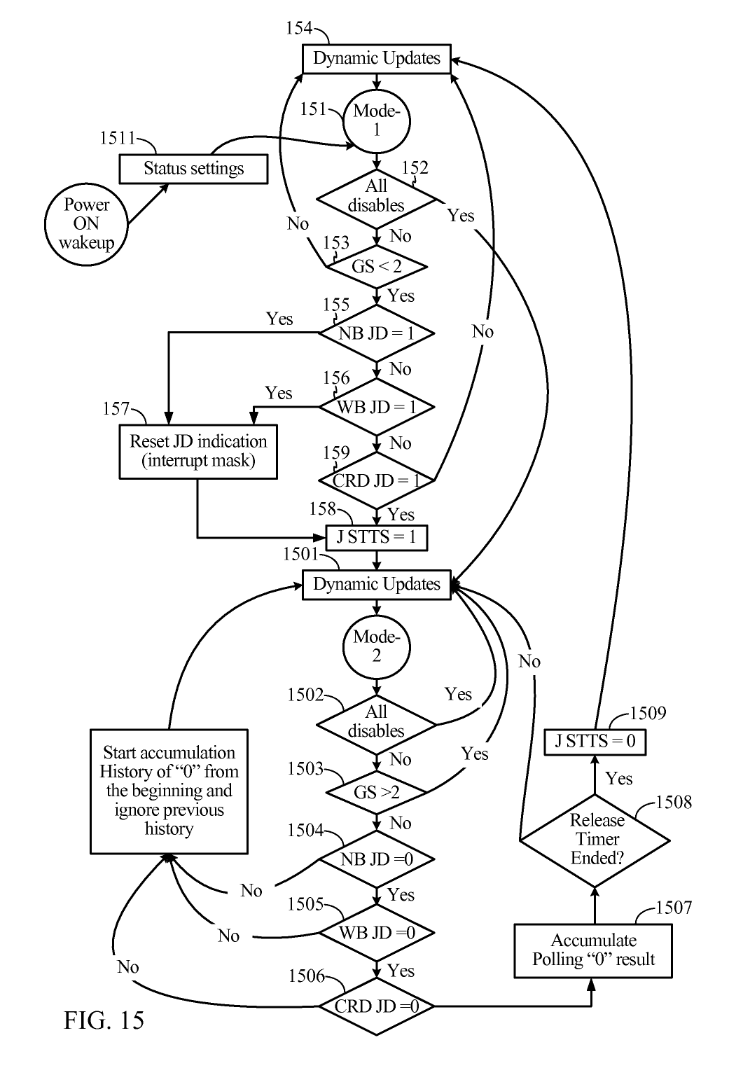

FIG. 15 illustrates operations for implementing jammer detection with adaptive fast attack/slow release response according to exemplary embodiments of the present work. In the example of FIG. 15, after power on/wake up, initial static settings are loaded at 1511, and operation begins in Mode 1 at 151. In some embodiments, the static settings at 1511 include count values for the JDC1 and JDC2 counters, and thresholds for the various jammer detectors at the various gain states. (An optional check of disable signals may be made at 152.) The Mode 1 gain state (GS) is checked at 153. If GS=G2 or greater, there is no need to monitor the JD interrupt signals, and dynamic parameter updates for Mode 1 are loaded at 154. If GS<G2 at 153, then JD interrupt signals for narrow band jammers and wideband jammers are monitored at 155 and 156. Activation of either interrupt signal 155 or 156 triggers resetting of all interrupt status bits and interrupt masking at 157, and commencement of transition to Mode 2 (J STTS=1). This is shown at 158. Absent interrupt signals at 155 or 156, transition to Mode 2 will also occur if the concurrent operation (CRD) jammer detector (also referred to herein as the software jammer detector or ChOrd) is active at 159. Operation remains in Mode 1 at 154 if none of the jammer detection interrupts 155, 156 or 159 trigger.

The transition from Mode 1 to Mode 2 continues at 1501 with dynamic parameter updates for Mode 2. (An optional check of disable signals may be made at 1502.) If the Mode 2 GS>G2 at 1503, there is no need to poll interrupt status bits, and dynamic parameter updates occur at 1501. If GS=G2 or less at 1503, polling of the interrupt status bits for the three jammer detectors begins (1504-1506). If all accumulated polling results are “0” at 1507 through the release time (see 1508), then operation transitions to Mode 1 (J STTS=1) at 1509. If any polling at 1504-1506 yields “1”, then, at 1510, all previous polling history is ignored and the polling for all JDs is restarted. Dynamic parameter updates for Mode 2 then occur at 1501.

As long as all accumulated polling results are “0” at 1507, but the release time has not yet expired at 1508, dynamic parameter updates for Mode 2 occur at 1501 after each interrupt status bit poll. In some embodiments, the dynamic parameter update 1501 occurs during a shaded time interval in FIG. 8, before the data burst in the next MLC slot.

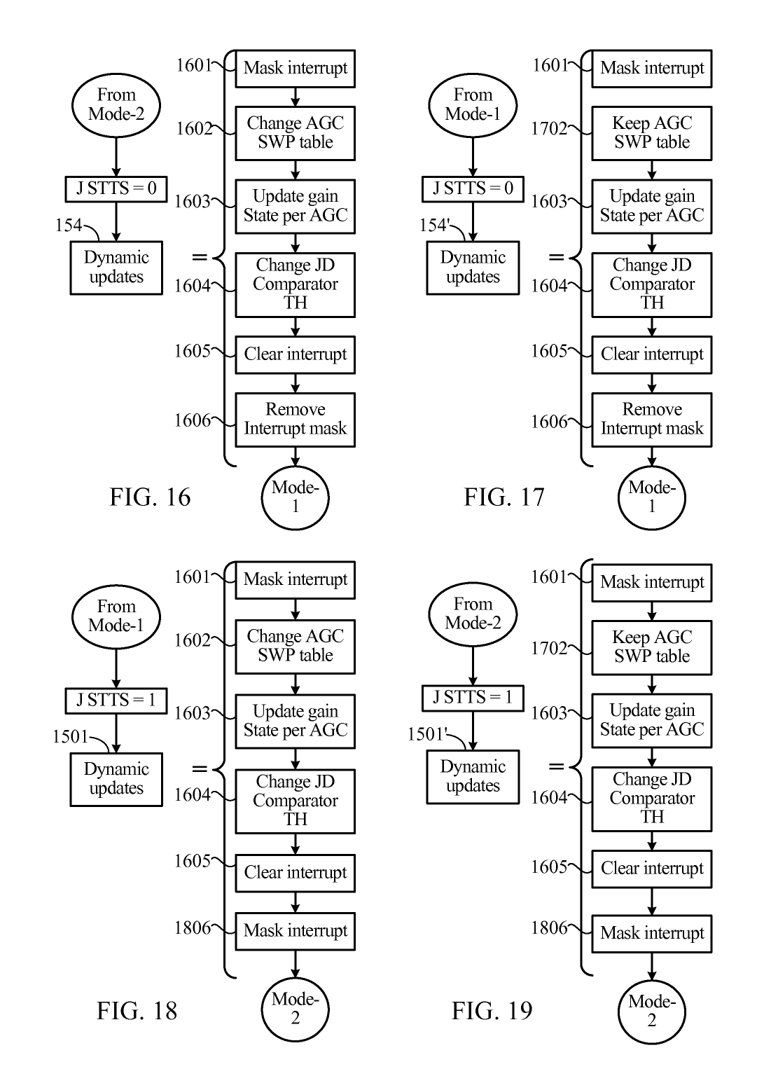

FIG. 16 illustrates the dynamic updates 154 for Mode 1 when transitioning from Mode 2. FIG. 17 illustrates dynamic updates 154′ for Mode 1 when Mode 1 is being retained. FIG. 18 illustrates the dynamic updates 1501 for Mode 2 when transitioning from Mode 1. FIG. 19 illustrates dynamic updates 1501′ for Mode 2 when Mode 2 is being retained. All of the dynamic update procedures of FIG. 16-19 have operations 1601 and 1603-1605 in common, namely, masking the JD interrupt signals (1601) to prevent transient hazards during the update, updating gain states (1603) and JD comparator thresholds (1604), and clearing the JD interrupt status bits (1605).

When Mode 1 is entered (FIG. 16) or retained (FIG. 17), the interrupt mask is removed (1606) at the end of the update. When Mode 2 is entered (FIG. 18) or retained (FIG. 19), the interrupt signals are masked (1806) at the end of the update.

When a mode change occurs (FIGS. 16 and 18), the AGC switch point table is correspondingly changed at 1602 to match the new mode. When the mode is retained (FIGS. 17 and 19), the AGC switch point table is retained at 1702.

In contrast to the present work described above, conventional jammer detectors do not make jammer detection decisions based on interrupt status bit polling history. In some embodiments of the present work, both the release time of the polling process and its resolution of observation may be software programmable for execution by a data processor (e.g., DSP). The polling process is applicable to both continuous and burst mode jammers.

In further contrast to the present work, conventional jammer detectors do not (1) address boundary conditions such as cold start wake up and waking from sleep mode for burst reception, (2) manage a plurality of jammer detectors, or (3) manage different AGC switch point tables for different operational modes in both continuous and burst mode jammer environments.

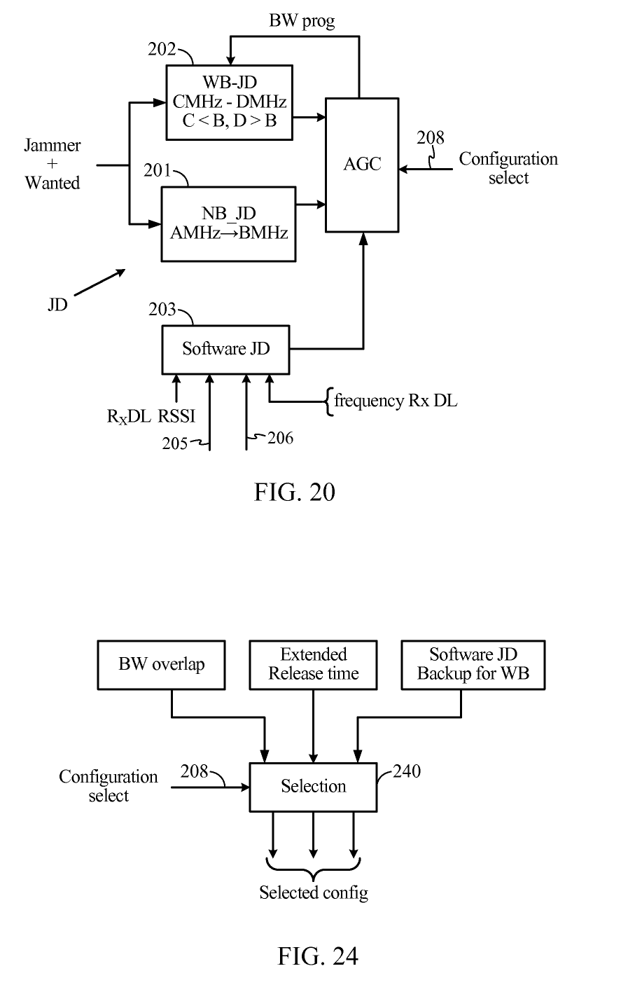

FIG. 20 diagrammatically illustrates the JD apparatus of FIG. 2 in more detail according to exemplary embodiments of the present work. The JD apparatus of FIG. 20 includes two hardware (HW) JDs, namely, a narrow band (NB) JD 201 and a wide band (WB) JD 202. The JD apparatus of FIG. 20 further includes a software (SW) JD 203, also referred to herein as ChOrd. In some embodiments, the SW JD 203 is implemented by the same data processor (e.g., microprocessor or DSP) that implements the AGC.

Each of the HW JDs 201 and 202 is designed to provide a hysteresis characteristic wherein each HW JD implements: (1) a tripping threshold which, when tripped by the input signal, indicates that a jammer is present; and (2) another threshold that is lower than the tripping threshold. An advantage of the hysteresis characteristic can be seen from the following discussion.

If the input trips the tripping threshold (tripping TH) during operation in Mode 1, the resulting switch to Mode 2 produces a correspondingly lower gain setting as described above. Without the aforementioned hysteresis characteristic (i.e., with only the single tripping threshold), this lower gain setting may attenuate the input below the tripping threshold, causing a switch back to Mode 1 operation, wherein the higher gain setting may drive the input above the tripping threshold, causing a switch back to Mode 2 operation. It can be seen that operation may disadvantageously toggle back and forth between Mode 1 and Mode 2.

The hysteresis effect achieved by adding the lower threshold (also referred to as the release threshold or release TH) is designed to prevent the aforementioned toggling between Mode 1 and Mode 2. In particular, the lower, release threshold is used, instead of the higher, tripping threshold, to control determination of the value of the JD status bit in Mode 2. This helps avoid mode toggling. The use of threshold hysteresis is well known in control system design, for example, in thermostat operation, wherein two different thresholds are commonly used to avoid unwanted toggling between a “heat on” state and a “heat off” state.

However, in both HW JDs 201 and 202, circuit design limitations may cause the hysteresis to exhibit a pinch-off (PO) characteristic near the upper frequency boundary of the JD's operational bandwidth (BW). More specifically, the higher and lower thresholds tend to converge near the upper BW boundary. This produces the aforementioned hysteresis pinch-off effect, which may result in unwanted mode toggling in the hysteresis pinch-off region near the upper BW boundary of the HW JD. The two thresholds also tend to increase as they converge near the upper BW boundary.

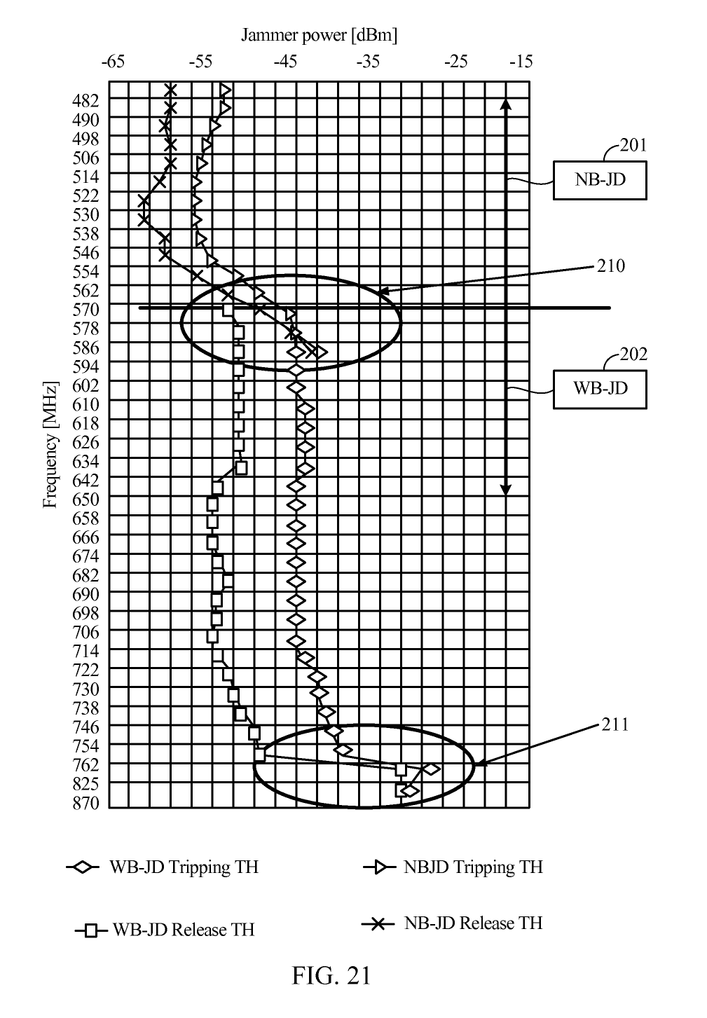

FIG. 21 graphically illustrates an example of the increasing, convergent behavior of the two thresholds in the hysteresis pinch-off regions 210 and 211 near the respective upper BW boundaries of the HW JDs 201 and 202. As shown in FIG. 21, the normal operational values of the two thresholds of the WB JD 202 are higher than the corresponding normal operational values of the two thresholds of the NB JD 201. However, in the hysteresis pinch-off region 210 of the NB JD 201, both of the increased, convergent thresholds of the NB JD 201 exceed both of the normal operating thresholds of the WB JD 202. Exemplary embodiments of the present work exploit this fact to mitigate unwanted toggling between Mode 1 and Mode 2 in the hysteresis pinch-off region 210 of NB JD 201.

In some embodiments, mitigation of mode toggling in the hysteresis pinch-off region of the NB JD 201 is achieved by designing the WB JD 202 such that its lower BW boundary overlaps the hysteresis pinch-off region of the NB JD 201. The fact that the normal operational threshold values of the WB JD 202 are lower than the threshold values of the NB JD 201 in the hysteresis pinch-off region of the NB JD 201 ensures that the normal operational threshold values of the WB JD 202 will be operational in the hysteresis pinch-off region of the NB JD 201. Therefore, the hysteresis effect is preserved, and mode toggling is avoided, in the hysteresis pinch-off region of the NB JD 201.

The above-described BW overlap between the WB JD 202 and the NB JD 201 is illustrated in FIG. 20, wherein the BW of the NB JD 201 extends from A MHz to B MHz, and the BW of the WB JD 202 extends from C MHz to D MHz, with C<B and D>B. In some embodiments, the BW overlap between the NB JD 201 and the WB JD 202 (i.e., B−C) is determined empirically based on observations of performance under anticipated operating conditions. As shown in FIG. 20, in some embodiments, the AGC may provide BW programming information (e.g., the value of C) to the WB JD 202, in order to configure the WB JD 202 appropriately to achieve the desired amount of BW overlap between WB JD 202 and NB JD 201.

Some embodiments implement a time hysteresis technique that selectively increases the Mode 2 release time (described in detail above) in order to avoid mode toggling due to hysteresis pinch-off. The time hysteresis technique maintains a record of mode switching versus time. If this record indicates an undesirably excessive amount of toggling between modes, then the Mode 2 release time is temporarily increased relative to the normal Mode 2 release time. That is, the period of time during which the JD interrupt status bit must remain “0” in Mode 2 before switching to Mode 1 is extended. For example, some embodiments implement the extended release time by requiring sampling of a larger number of superframes (e.g., more than three) than would normally be sampled in Mode 2.

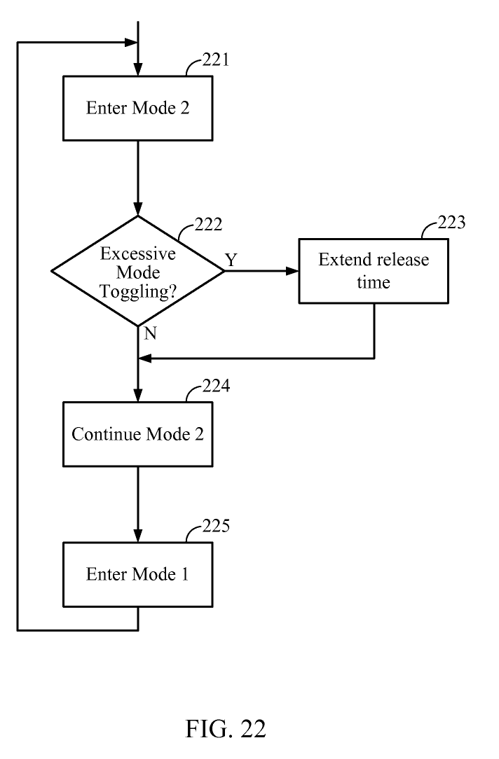

FIG. 22 illustrates operations that may be performed to implement the time hysteresis technique according to exemplary embodiments of the present work. In some embodiments, the AGC is capable of performing the operations of FIG. 22. As shown in FIG. 22, Mode 2 is entered at 221. At this point, the normal Mode 2 release time is in effect. At 222, the mode switching record is inspected in order to determine whether excessive mode toggling is occurring. If so, the Mode 2 release time is increased (extended) at 223. Mode 2 operations then continue at 224 as usual, but with the extended release time. Thereafter, upon compliance with the extended Mode 2 release time, Mode 1 may be entered at 225. Upon the next entry into Mode 2 at 221, the normal release time is in effect once again, but the mode switching record is consulted at 222 to determine whether excessive mode toggling warrants increasing the Mode 2 release time. In some embodiments, the amount by which the release time is increased at 223 is determined empirically based on observations of performance under anticipated operating conditions. In some embodiments, a threshold for use in determining excessive mode toggling (at 222) is determined empirically based on observations of performance under anticipated operating conditions. In some embodiments, the release time is extended even further if it is determined that an extended release time currently in use continues to result in excessive mode toggling.

Referring again to FIG. 20, the SW JD 203 provides backup protection against mode toggling when the WB JD 202 is tripped by a concurrent jammer. There are generally two types of concurrent jammers: (1) a transmit jammer that leaks into the victim receiver due to a transmission (e.g., an uplink transmission to a base station) from a multi-radio platform in which the victim receiver is provided; and (2) a receive jammer that leaks into the victim receiver due to a downlink reception at the victim receiver from, for example, a base station. The SW JD 203 generally has knowledge of the existence of such concurrent jammers because they correspond to scheduled transmissions and receptions occurring at the platform in which the victim receiver is provided.

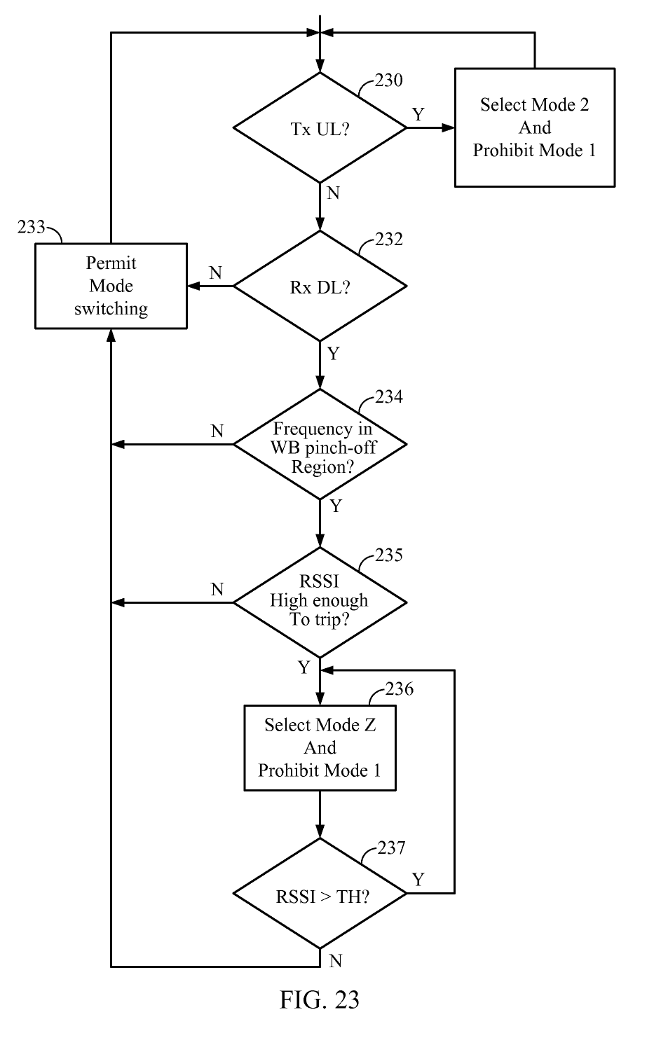

FIG. 23 illustrates operations that may be performed by the SW JD 203 according to exemplary embodiments of the present work to avoid mode toggling that may otherwise occur due to concurrent jammers acting in the pinch-off region of the WB JD 202 (see also FIG. 21). If an uplink transmission (Tx UL) is occurring at 230 then, at 231, Mode 2 is selected and Mode 1 is prohibited. If no uplink transmission is occurring at 230, then it is determined at 232 whether a downlink reception (Rx DL) is occurring. If not, switching between Mode 1 and Mode 2 is permitted as usual at 233, and operations return to 230.

If a downlink reception is occurring at 232, it is then determined at 234 whether the reception frequency (knowledge of which is conventionally available in the receiver) is within the hysteresis pinch-off region of the WB JD 202. If not, then normal mode switching is permitted at 233. If the reception frequency is within the hysteresis pinch-off region of the WB JD, then it is determined at 235 whether the (conventionally available) RSSI of the reception is in a signal strength range that could trip the WB JD thresholds in the hysteresis pinch-off region. If not, normal mode switching is permitted at 233. If at 235 the RSSI of the reception is in a signal strength range that could trip the WB JD thresholds in the hysteresis pinch-off region, then, at 236, Mode 2 is selected and Mode 1 is prohibited.

While Mode 2 is selected and Mode 1 is prohibited during a downlink reception, the RSSI of the reception is compared to an RSSI threshold (TH) at 237. If the RSSI exceeds the threshold, then selection of Mode 2 and prevention of Mode 1 is maintained at 236. If the RSSI does not exceed the threshold at 237, then mode switching is permitted as usual at 233. In some embodiments, the RSSI threshold is determined empirically based on observations of performance under anticipated operating conditions. In some embodiments, the threshold value used at 237 is also used as the RSSI decision criterion at 235.

FIG. 20 shows that, in some embodiments, the SW JD 203 receives as input the downlink reception frequency and RSSI, as well as indications 205 regarding when uplink transmissions and downlink receptions occur. The information represented by these inputs is conventionally available in the platform in which the victim receiver resides.

FIG. 20 also illustrates that, in some embodiments, the AGC receives configuration selection information (e.g., from a jammer control portion of the processor that implements the AGC) at 208. The configuration selection information 208 may instruct the AGC to implement any one of, or any combination of, the above-described hysteresis pinch-off mitigation techniques. As shown in FIG. 24, in some embodiments, the AGC includes configuration selection logic 240 that is responsive to the configuration selection information 208 to select any one, two, or all three of the hysteresis pinch-off mitigation techniques, thereby providing for the implementation of any desired one of seven possible hysteresis pinch-off mitigation strategies.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present work.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use products that embody principles of the present work. Various modifications to these embodiments will be readily apparent to those skilled in the art, and the generic principles defined herein may be applied to other embodiments without departing from the spirit or scope of the disclosure. Thus, the present work is not intended to be limited to the embodiments shown herein but is to be accorded the widest scope consistent with the principles and novel features disclosed herein.

What is claimed is:

1. A method of protecting a receiver that receives an input signal including a desired signal combined with intermittent jammer activity, comprising:
amplifying the input signal according to a first amplification characteristic;
during said amplifying, observing jammer indications adapted to indicate whether jammer activity is present in respectively corresponding portions of the input signal that are temporally distinct from one another;
continuing said amplifying until a plurality of said observed jammer indications indicate absence of jammer activity in each of a plurality of respectively corresponding, consecutive ones of said input signal portions; and
commencing amplifying the input signal according to a second amplification characteristic having a higher input sensitivity than the first amplification characteristic, only in response to said plurality of observed jammer indications indicating absence of jammer activity in each of said plurality of consecutive input signal portions.

2. The method of claim 1, including, during said last-mentioned amplifying, continuously monitoring an interrupt signal that indicates whether jammer activity is present in the input signal.

3. The method of claim 1, wherein said observing includes observing said jammer indications during respective time intervals of the corresponding input signal portions.

4. The method of claim 3, including restarting said observing immediately if any of said observed jammer indications indicates presence of jammer activity in the input signal.

5. The method of claim 3, wherein said observing includes observing each of said jammer indications during a latter half of the corresponding time interval.

6. The method of claim 1, including maintaining a history of said observed jammer indications, and using said history to decide whether to amplify a next said input portion according to said first characteristic or said second characteristic.

7. The method of claim 1, wherein said first amplification characteristic includes a first gain and a first noise figure and said second amplification characteristic includes a second gain that is higher than said first gain and a second noise figure that is lower than said first noise figure.

8. The method of claim 7, including, during one of said amplifying steps, executing a first transition from amplifying according to the associated one of said first and second amplification characteristics to amplifying according to a third amplification characteristic that includes a third gain and a third noise figure.

9. The method of claim 8, including, during the other of said amplifying steps, executing a second transition from amplifying according to the associated one of said first and second amplification characteristics to amplifying according to a fourth amplification characteristic that includes a fourth gain and a fourth noise figure.

10. The method of claim 9, wherein said third gain differs from said fourth gain, and said third noise figure differs from said fourth noise figure.

11. The method of claim 9, wherein said first and second transitions are executed based respectively on first and second switching criteria.

12. The method of claim 11, including using a first jammer detection threshold to detect jammer activity in the input signal during one of said amplifying steps, and using a second jammer detection threshold to detect jammer activity in the input signal during the other of said amplifying steps.

13. The method of claim 11, wherein said first and second switching criteria correspond to a same characteristic of the input signal.

14. The method of claim 13, wherein said same characteristic is power.

15. The method of claim 1, including using a first jammer detection threshold to detect jammer activity in the input signal during one of said amplifying steps, and using a second jammer detection threshold to detect jammer activity in the input signal during the other of said amplifying steps.

16. The method of claim 1, wherein said jammer activity includes narrow band jammer activity and wideband jammer activity.

17. A receiver apparatus that receives an input signal including a desired signal combined with intermittent jammer activity, comprising:
a first amplifier for amplifying the input signal according to a first amplification characteristic;
a second amplifier for amplifying the input signal according to a second amplification characteristic having a higher input sensitivity than the first amplification characteristic; and
a controller coupled to said first and second amplifiers and configured to select either of said first and second amplifiers to amplify the input signal;
said controller configured to, while said first amplifier is selected, observe jammer indications adapted to indicate whether jammer activity is present in respectively corresponding portions of the input signal that are temporally distinct from one another;
said controller configured to maintain selection of said first amplifier until a plurality of said observed jammer indications indicate absence of jammer activity in each of a plurality of respectively corresponding, consecutive ones of said input signal portions; and
said controller configured to switch from selection of said first amplifier to selection of said second amplifier only in response to said plurality of observed jammer indications indicating absence of jammer activity in each of said plurality of consecutive input signal portions.

18. The method of claim 17, wherein said controller is configured to, while said second amplifier is selected, continuously monitor an interrupt signal that indicates whether jammer activity is present in the input signal.

19. The method of claim 17, wherein said controller is configured to observe said jammer indications during respective time intervals of the corresponding input signal portions.

20. The method of claim 19, wherein said controller is configured to restart said observing immediately if any of said observed jammer indications indicates presence of jammer activity in the input signal.

21. The method of claim 19, wherein said controller is configured to observe each of said jammer indications during a latter half of the corresponding time interval.

22. The method of claim 17, wherein said controller is configured to maintain a history of said observed jammer indications, and to use said history to decide which of said first and second amplifiers to select for amplifying a next said input portion.

23. The method of claim 17, wherein said first amplification characteristic includes a first gain and a first noise figure and said second amplification characteristic includes a second gain that is higher than said first gain and a second noise figure that is lower than said first noise figure.

24. The method of claim 23, wherein said controller is configured to, while one of said first and second amplifiers is selected, cause a first transition from amplifying according to the associated one of said first and second amplification characteristics to amplifying according to a third amplification characteristic that includes a third gain and a third noise figure.

25. The method of claim 24, wherein said controller is configured to, while the other of said first and second amplifiers is selected, cause a second transition from amplifying according to the associated one of said first and second amplification characteristics to amplifying according to a fourth amplification characteristic that includes a fourth gain and a fourth noise figure.

26. The method of claim 25, wherein said third gain differs from said fourth gain, and said third noise figure differs from said fourth noise figure.

27. The method of claim 25, wherein said controller is configured to cause said first and second transitions based respectively on first and second switching criteria.

28. The method of claim 27, including a jammer detector coupled to said controller and configured to use a first jammer detection threshold to detect jammer activity in the input signal while one of said first and second amplifiers is selected, and to use a second jammer detection threshold to detect jammer activity in the input signal while the other of said first and second amplifiers is selected.

29. The method of claim 27, wherein said first and second switching criteria correspond to a same characteristic of the input signal.

30. The method of claim 29, wherein said same characteristic is power.

31. The method of claim 17, including a jammer detector coupled to said controller and configured to use a first jammer detection threshold to detect jammer activity in the input signal while one of said first and second amplifiers is selected, and to use a second jammer detection threshold to detect jammer activity in the input signal while the other of said first and second amplifiers is selected.

32. An apparatus for protecting a receiver that receives an input signal including a desired signal combined with intermittent jammer activity, comprising:
means for amplifying the input signal according to a first amplification characteristic;
means operable during said amplifying according to said first amplification characteristic for observing jammer indications adapted to indicate whether jammer activity is present in respectively corresponding portions of the input signal that are temporally distinct from one another;
means for continuing said amplifying according to said first amplification characteristic until a plurality of said observed jammer indications indicate absence of jammer activity in each of a plurality of respectively corresponding, consecutive ones of said input signal portions; and
means for commencing amplifying the input signal according to a second amplification characteristic having a higher input sensitivity than the first amplification characteristic, only in response to said plurality of observed jammer indications indicating absence of jammer activity in each of said plurality of consecutive input signal portions.

33. A computer program product for supporting a receiver that receives an input signal including a desired signal combined with intermittent jammer activity, comprising:
a computer readable medium comprising:
code for causing at least one data processor to select amplification of the input signal according to a first amplification characteristic;
code for causing the at least one data processor to, during said amplification according to said first amplification characteristic, observe jammer indications adapted to indicate whether jammer activity is present in respectively corresponding portions of the input signal that are temporally distinct from one another;
code for causing the at least one data processor to maintain said selection of amplification according to said first amplification characteristic until a plurality of said observed jammer indications indicate absence of jammer activity in each of a plurality of respectively corresponding, consecutive ones of said input signal portions; and
code for causing the at least one data processor to select amplification of the input signal according to a second amplification characteristic having a higher input sensitivity than the first amplification characteristic, only in response to said plurality of observed jammer indications indicating absence of jammer activity in each of said plurality of consecutive input signal portions.
